(19) United States
(12) Patent Application Publication
(10) Pub. No.: US 2025/0214839 A1
(43) Pub. Date: Jul. 3, 2025

(54) POROUS IRON PHOSPHATE AND PREPARATION METHOD THEREFOR

(71) Applicants: Guangdong Brunp Recycling Technology Co., Ltd., Foshan, Guangdong (CN); Hunan Brunp Recycling Technology Co., Ltd., Changsha, Hunan (CN); Hunan Brunp EV Recycling Co., Ltd., Changsha, Hunan (CN)

(72) Inventors: Haijun Yu, Foshan, Guangdong (CN); Yinghao Xie, Foshan, Guangdong (CN); Aixia Li, Foshan, Guangdong (CN); Xuemei Zhang, Foshan, Guangdong (CN); Changdong Li, Foshan, Guangdong (CN)

(21) Appl. No.: 18/850,166

(22) PCT Filed: Mar. 16, 2023
(86) PCT No.: PCT/CN2023/081944

§ 371 Date: Sep. 24, 2024

(30) Foreign Application Priority Data
May 20, 2022 (CN) 202210549325.X

(51) Int. Cl. C01B 25/37; C01B 25/45; H01M 4/02; H01M 4/58; H01M 10/0525

(52) U.S. Cl. CPC C01B 25/375; C01B 25/45; H01M 4/5825; H01M 10/0525; C01P 2004/03; C01P 2006/40; C01P 2006/90; H01M 2004/028

(57) ABSTRACT

The present disclosure discloses a porous iron phosphate and a preparation method thereof. The preparation method includes the following steps: (1) mixing a phosphorus-iron solution with an aluminum-containing alkaline solution to allow a co-precipitation reaction; (2) subjecting a reaction system obtained in step (1) to solid-liquid separation (SLS) to obtain a precipitate; (3) subjecting the precipitate obtained in step (2) to a reaction with phosphine under heating; (4) after the reaction is completed, cooling a product obtained in step (3), and soaking the product in a weak acid solution; and (5) subjecting a system obtained in step (4) to SLS to obtain a solid, and subjecting the solid to aerobic calcination to obtain the porous iron phosphate.

### TECHNICAL FIELD

The present disclosure belongs to the technical field of cathode materials for lithium batteries, and particularly relates to a porous ferric phosphate and a preparation method therefor.

### BACKGROUND

With the continuous development of the electric vehicle market, more and more attention has been paid to the safety and economy of electric vehicles, especially the safety. Fire accidents of power supplies of electric vehicles are often reported. A power supply is a key component of an electric vehicle, and lithium-ion batteries (LIBs) are recognized as the most ideal power supply. Whether LIBs can be widely used mainly depends on their indexes such as performance, price, and safety. As a cathode material is a core component of an LIB, the cost and performance of the cathode material will directly affect the overall cost and performance of the battery. Therefore, the development of cathode materials with excellent performance and low price is the focus of LIB research.

Lithium ferric phosphate (LFP) batteries exhibit higher safety and lower cost advantages than ternary batteries, and have advantages such as high thermal stability, long cycling life, environmental friendliness, and rich raw material sources. LFP cathode materials are currently the most potential cathode materials for LIBs and are favored by more and more automobile manufacturers, and a market share of LFP continues to increase.

The process route of synthesizing LFP from ferric phosphate is one of the most widely used technical routes for preparing LFP. Compared with the process of synthesizing LFP from ferrous oxalate or iron oxide red, the process route of synthesizing LFP from ferric phosphate has a high sintering product ratio, and a product thereof has a smaller particle size and excellent low-temperature performance and rate performance. An LFP crystal can grow directly on the basis of a ferric phosphate crystal. The performance of ferric phosphate directly determines the performance of LFP, and a cost of ferric phosphate accounts for about 50% of a cost of LFP raw materials. It can be known that the preparation of economical battery-grade ferric phosphate precursors with excellent performance is a key in the field of LFP batteries. In the general preparation method for battery-grade ferric phosphate, a ferrous salt is used as an iron source, and a chemical oxidizing agent such as hydrogen peroxide needs to be introduced for oxidation, resulting in higher cost. In addition, the microscopic size and structural characteristics of ferric phosphate have a greater influence on the morphological structure and electrochemical performance of LFP. Therefore, in order to maximize the performance of LFP materials, higher requirements are presented on the morphology and other characteristics of ferric phosphate precursors.

### SUMMARY

The present disclosure is intended to solve at least one of the technical problems existing in the prior art. In view of this, the present disclosure provides a porous ferric phosphate and a preparation method therefor. The preparation method can lead to a ferric phosphate material with a porous structure, thereby improving the electrochemical performance of an LFP material prepared subsequently.

The above technical objective of the present disclosure is achieved by the following technical solutions.

A preparation method for a porous ferric phosphate is provided, including the following steps:
(1) mixing a phosphorus-iron solution with an aluminum-containing alkaline solution to allow a co-precipitation reaction;
(2) subjecting a reacted system obtained in step (1) to solid-liquid separation (SLS) to obtain a precipitate;
(3) subjecting the precipitate obtained in step (2) to a reaction with phosphine under heating;
(4) after the reaction is completed, cooling a precipitate treated in step (3), and soaking a cooled precipitate in a weak acid solution; and
(5) subjecting a system obtained in step (4) to SLS to obtain a solid, and subjecting the solid to aerobic calcination.

Preferably, the phosphorus-iron solution may be prepared from an iron source, a phosphorus source, and a strong acid; and in the phosphorus-iron solution, a molar ratio of iron element to phosphorus element may be 1.0 to 1.6 and a concentration of iron ions may be 0.5 mol/L to 2.0 mol/L.

Preferably, the phosphorus-iron solution may have a pH less than 1.

Preferably, the iron source may be at least one of iron sulfate, iron chloride, and iron nitrate.

Preferably, the phosphorus source may be at least one of phosphoric acid and dihydrogen phosphate.

Preferably, the strong acid may be at least one of sulfuric acid, hydrochloric acid, and nitric acid.

Preferably, in the aluminum-containing alkaline solution, a concentration of sodium hydroxide may be 1.0 mol/L to 4.0 mol/L and a concentration of sodium tetrahydroxoaluminate may be 0.05 mol/L to 0.4 mol/L.

Preferably, the mixing in step (1) may be conducted as follows: concurrently feeding the phosphorus-iron solution and the aluminum-containing alkaline solution into a reactor to allow a reaction at 80° C. to 95° C., during which a reaction system is continuously stirred and a pH of the reaction system is controlled at 5 to 6.

Preferably, in step (1), after the feeding is completed, aging may be conducted for 1 h to 2 h.

Preferably, in step (2), the drying may be conducted at 100° C. to 120° C. for 4 h to 6 h.

Preferably, in step (3), the precipitate may be placed at a lower vent of a tube furnace, and anhydrous sodium hypophosphite may be placed at an upper vent of the tube furnace and heated for decomposition to produce a phosphine gas, where a mass ratio of the anhydrous sodium hypophosphite to the precipitate is (4-8):1.

Preferably, the heating in the tube furnace in step (3) may be conducted as follows: heating at a heating rate of 2° C./min to 5° C./min to 300° C. to 400° C., and holding the temperature for 120 min to 180 min.

Preferably, the weak acid solution in step (4) may be an acetic acid solution with a concentration of 0.1 mol/L to 0.5 mol/L.

Preferably, in step (4), the precipitate may be cooled to 10° C. or lower, and then soaked in the weak acid solution at 2° C. to 10° C. according to a solid-to-liquid ratio (a ratio of a mass of the precipitate to a volume of the weak acid solution) of 1 to 5 g/mL.

Preferably, in step (4), the soaking may be conducted for 10 min to 30 min.

Preferably, the aerobic calcination in step (5) may be conducted at 500° C. to 800° C. for 0.5 h to 1 h.

Preferably, a preparation method for a porous ferric phosphate may be provided, including the following steps:
S1. preparing a phosphorus-iron solution from an iron source, a phosphorus source, and a strong acid, where in the phosphorus-iron solution, a molar ratio of iron element to phosphorus element is 1.0 to 1.6 and a concentration of iron ions is 0.5 mol/L to 2.0 mol/L; the phosphorus-iron solution has a pH less than 1; the iron source is at least one of iron sulfate, iron chloride, and iron nitrate; the phosphorus source is at least one of phosphoric acid and dihydrogen phosphate; and the pH is adjusted with at least one of sulfuric acid, hydrochloric acid, and nitric acid;
S2. preparing an aluminum-containing alkaline solution, where in the aluminum-containing alkaline solution, a concentration of sodium hydroxide is 1.0 mol/L to 4.0 mol/L and a concentration of sodium tetrahydroxoaluminate is 0.05 mol/L to 0.4 mol/L;
S3. concurrently feeding the phosphorus-iron solution prepared in S1 and the aluminum-containing alkaline solution prepared in S2 into a reactor to allow a reaction at a stirring speed of 200 r/min to 500 r/min, a pH of 5 to 6, and a temperature of 80° C. to 95° C.;
S4. after the feeding is completed, aging for 1 h to 2 h;
S5. subjecting an aged system in the reactor to SLS to obtain a precipitate, subjecting the precipitate to washing with pure water and then to drying at 100° C. to 120° C. for 4 h to 6 h, and placing the dried precipitate at a lower vent of a tube furnace;
S6. placing anhydrous sodium hypophosphite at an upper vent of the tube furnace, where a mass ratio of the anhydrous sodium hypophosphite to the precipitate is (4-8):1;
S7. heating the tube furnace at a heating rate of 2° C./min to 5° C./min to 300° C. to 400° C., and holding the temperature for 120 min to 180 min;
S8. after the reaction is completed, taking out a precipitate, cooling the precipitate to 10° C. or lower, and soaking the precipitate in a 0.1 mol/L to 0.5 mol/L acetic acid solution at 2° C. to 10° C. for 10 min to 30 min according to a solid-to-liquid ratio of 1 to 5 g/mL; and
S9. conducting SLS to obtain a separated precipitate, washing the separated precipitate with deionized water, and subjecting the washed precipitate to calcination at 500° C. to 800° C. for 0.5 h to 1 h in an oxygen atmosphere to obtain the porous ferric phosphate material.

A porous ferric phosphate prepared by the preparation method described above is provided.

The present disclosure has the following beneficial effects.

(1) In the present disclosure, an acidic solution containing phosphorus and iron and an aluminum-containing alkaline solution are concurrently fed for precipitation to produce a mixed precipitate of ferric phosphate, iron hydroxide, and aluminum hydroxide; then sodium hypophosphite is decomposed to produce phosphine, and the phosphine reacts with the iron hydroxide to produce iron phosphide; and finally aluminum is removed through dissolution in a weak acid, and calcination is conducted to obtain a porous ferric phosphate material. Reaction equations are as follows:

### Co-precipitation Reactions:

[Al(OH)₄]⁻+H⁺→Al(OH)₃+H₂O
Fe³⁺+PO₄³⁻→FePO₄
Fe³⁺+3OH⁻→Fe(OH)₃.

### Reactions of the Precipitate and the Anhydrous Sodium Hypophosphite Under Heating:

2NaH₂PO₂→PH₃+Na₂HPO₄
PH₃+Fe(OH)₃→FeP+3H₂O.

### Reaction for Soaking in the Weak Acid:

Al(OH)₃+3H⁺→Al³⁺+3H₂O (which makes atomic vacancies left in the precipitate crystal).

### Reaction for Calcination in Oxygen:

FeP+2O₂→FePO₄.

(2) In the present disclosure, phosphorus and iron are allowed to coexist in a solution by controlling a pH, and during precipitation, aluminum in the aluminum-containing alkaline solution will only exist in the form of aluminum hydroxide and the aluminum phosphate precipitate will not be produced, which is conducive to the subsequent aluminum removal to form a porous structure; moreover, phosphate radical will react with ferric iron to produce ferric phosphate, during which iron hydroxide is inevitably produced; a phosphide is produced through further reaction of iron hydroxide and phosphine, and a weak acid is used to remove aluminum, such that atomic vacancies are left in the precipitate crystal to form a porous structure; and finally, calcination is conducted to obtain a porous ferric phosphate material.

(3) The ferric phosphate obtained by the present disclosure has a porous structure, which is beneficial to the subsequent sintering with a lithium source. Due to the aluminum removal, atomic vacancies are left to further improve the specific capacity of the material.

### BRIEF DESCRIPTION OF THE DRAWINGS

FIG. 1 is a scanning electron microscopy (SEM) image of the porous ferric phosphate prepared in Example 1 of the present disclosure.

### DETAILED DESCRIPTION

The present disclosure is further described below with reference to specific Examples.

### Example 1

A preparation method for a porous ferric phosphate was provided, including the following steps:
S1. a phosphorus-iron solution was prepared from iron sulfate, phosphoric acid, and sulfuric acid, where in the phosphorus-iron solution, a molar ratio of iron element to phosphorus element was 1.3:1 and a concentration of iron ions was 1.0 mol/L; and the phosphorus-iron solution had a pH of 0.8;
S2. an aluminum-containing alkaline solution was prepared, where in the aluminum-containing alkaline solution, a concentration of sodium hydroxide was 2.0 mol/L and a concentration of sodium tetrahydroxoaluminate was 0.2 mol/L;
S3. the phosphorus-iron solution prepared in S1 and the aluminum-containing alkaline solution prepared in S2 were concurrently fed into a reactor to allow a reaction at a stirring speed of 350 r/min, a pH of 5.5, and a temperature of 88° C.;
S4. after the feeding was completed, aging was conducted for 1.5 h;
S5. an aged system in the reactor was subjected to SLS to obtain a precipitate, and the precipitate was washed with pure water, then dried at 110° C. for 5 h, and placed at a lower vent of a tube furnace;
S6. anhydrous sodium hypophosphite was placed at an upper vent of the tube furnace, where a mass ratio of the anhydrous sodium hypophosphite to the precipitate was 6:1;
S7. the tube furnace was heated at a heating rate of 3° C./min to 350° C., and kept at the temperature for 150 min;
S8. after the reaction was completed, the precipitate was taken out, cooled to 6° C., and soaked in a 0.2 mol/L acetic acid solution at 6° C. for 20 min according to a solid-to-liquid ratio of 2 g/mL; and
S9. SLS was conducted to obtain a precipitate, and the precipitate was washed with deionized water and then subjected to calcination at 700° C. for 0.5 h in an oxygen atmosphere to obtain the porous ferric phosphate material.

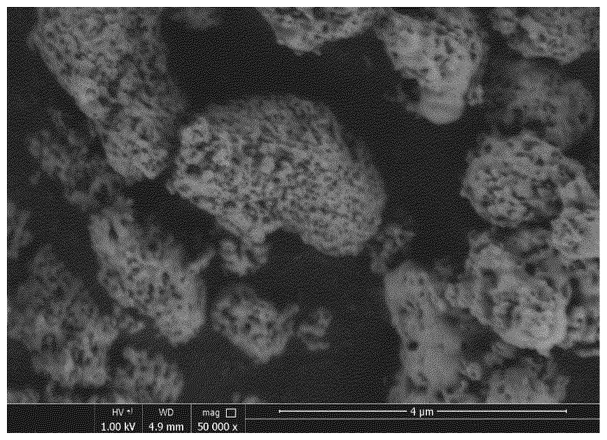

A porous ferric phosphate prepared by the preparation method described above was provided, and an SEM image thereof was shown in FIG. 1.

### Example 2

A preparation method for a porous ferric phosphate was provided, including the following steps:
S1. a phosphorus-iron solution was prepared from iron chloride, sodium dihydrogen phosphate, and hydrochloric acid, where in the phosphorus-iron solution, a molar ratio of iron element to phosphorus element was 1.0:1 and a concentration of iron ions was 0.5 mol/L; and the phosphorus-iron solution had a pH of 0.8;
S2. an aluminum-containing alkaline solution was prepared, where in the aluminum-containing alkaline solution, a concentration of sodium hydroxide was 1.0 mol/L and a concentration of sodium tetrahydroxoaluminate was 0.05 mol/L;
S3. the phosphorus-iron solution prepared in S1 and the aluminum-containing alkaline solution prepared in S2 were concurrently fed into a reactor to allow a reaction at a stirring speed of 200 r/min, a pH of 5, and a temperature of 80° C.;
S4. after the feeding was completed, aging was conducted for 1 h;
S5. an aged system in the reactor was subjected to SLS to obtain a precipitate, and the precipitate was washed with pure water, then dried at 100° C. for 6 h, and placed at a lower vent of a tube furnace;
S6. anhydrous sodium hypophosphite was placed at an upper vent of the tube furnace, where a mass ratio of the anhydrous sodium hypophosphite to the precipitate was 4:1;
S7. the tube furnace was heated at a heating rate of 2° C./min to 300° C., and kept at the temperature for 120 min;
S8. after the reaction was completed, the precipitate was taken out, cooled to 2° C., and soaked in a 0.1 mol/L acetic acid solution at 2° C. for 30 min according to a solid-to-liquid ratio of 1 g/mL; and
S9. SLS was conducted to obtain a precipitate, and the precipitate was washed with deionized water and then subjected to calcination at 500° C. for 1 h in an oxygen atmosphere to obtain the porous ferric phosphate material.

A porous ferric phosphate prepared by the preparation method described above was provided.

### Example 3

A preparation method for a porous ferric phosphate was provided, including the following steps:
S1. a phosphorus-iron solution was prepared from iron nitrate, potassium dihydrogen phosphate, and nitric acid, where in the phosphorus-iron solution, a molar ratio of iron element to phosphorus clement was 1.6:1 and a concentration of iron ions was 2.0 mol/L; and the phosphorus-iron solution had a pH of 0.8;
S2. an aluminum-containing alkaline solution was prepared, where in the aluminum-containing alkaline solution, a concentration of sodium hydroxide was 4.0 mol/L and a concentration of sodium tetrahydroxoaluminate was 0.4 mol/L;
S3. the phosphorus-iron solution prepared in S1 and the aluminum-containing alkaline solution prepared in S2 were concurrently fed into a reactor to allow a reaction at a stirring speed of 500 r/min, a pH of 6, and a temperature of 95° C.;
S4. after the feeding was completed, aging was conducted for 2 h;
S5. an aged system in the reactor was subjected to SLS to obtain a precipitate, and the precipitate was washed with pure water, then dried at 120° C. for 4 h, and placed at a lower vent of a tube furnace;
S6. anhydrous sodium hypophosphite was placed at an upper vent of the tube furnace, where a mass ratio of the anhydrous sodium hypophosphite to the precipitate was 8:1;
S7. the tube furnace was heated at a heating rate of 5° C./min to 400° C., and kept at the temperature for 180 min;
S8. after the reaction was completed, the precipitate was taken out, cooled to 9° C., and soaked in a 0.5 mol/L acetic acid solution at 10° C. for 30 min according to a solid-to-liquid ratio of 5 g/mL; and
S9. SLS was conducted to obtain a precipitate, and the precipitate was washed with deionized water and then subjected to calcination at 800° C. for 0.5 h in an oxygen atmosphere to obtain the porous ferric phosphate material.

A porous ferric phosphate prepared by the preparation method described above was provided.

### Comparative Example 1

A preparation method for a ferric phosphate was provided, including the following steps:
S1. ferrous sulfate and sodium dihydrogen phosphate were taken in equimolar amounts and dissolved in water to obtain a solution with a ferrous ion concentration of 90 g/L, and the solution was placed in a reactor;
S2. hydrogen peroxide with excess by 20% was added to the reactor;
S3. the reactor was heated to 90° C., then a pH was adjusted to 1.8 with sodium hydroxide, and the reactor was kept at the temperature for 1 h;
S4. SLS was conducted to obtain a precipitate, and then the precipitate was washed with pure water to obtain a filter cake;
S5. the filter cake was dried at 105° C. for 8 h and then crushed to obtain ferric phosphate dihydrate; and
S6. the ferric phosphate dihydrate was subjected to calcination in a muffle furnace at 550° C. for 3 h to obtain the ferric phosphate.

A ferric phosphate prepared by the preparation method described above was provided.

### Test Example

According to a specified molar ratio of elements in the chemical formula (Li:P:Fe:glucose=1:1:1:1), the ferric phosphate obtained from each of Examples 1 to 3 and Comparative Example 1 was mixed with glucose and lithium carbonate in deionized water, and a resulting mixture was thoroughly stirred in a mixing tank, then spray-dried, kept at 580° C. for 9 h in an inert atmosphere, and crushed to obtain LFP.

The LFP prepared above (as a cathode material), acetylene black (as a conductive agent), and polyvinylidene fluoride (PVDF) (as a binder) were weighed and mixed in a ratio of 92:4:4, then a specified amount of an organic solvent N-methylpyrrolidone (NMP) was added, and a resulting mixture was stirred and coated on an aluminum foil to obtain a positive electrode sheet; and then with a metal lithium sheet as a negative electrode, a button battery was assembled in an argon-filled glove box. The electrochemical performance of the button battery was tested, and results were shown in Table 1.

TABLE 1
Electrochemical performance of batteries

| | Discharge | Capacity | | Capacity |
|---|---|---|---|---|
| | capacity at | retention | Discharge | retention rate |
| | 0.1 C, | rate after 100 | capacity at 1 | after 100 cycles |
| | mAh/g | cycles at 0.1 C | C, mAh/g | at 1 C |
| Example 1 | 166.3 | 97.3% | 149.6 | 95.1% |
| Example 2 | 165.6 | 97.6% | 149.4 | 94.3% |
| Example 3 | 164.4 | 97.1% | 149.3 | 94.5% |
| Comparative | 152.0 | 92.1% | 138.0 | 87.3% |
| Example 1 | | | | |

It can be seen from Table 1 that a cathode material prepared from the porous ferric phosphate of the present disclosure has prominent electrochemical performance, with a discharge capacity at 0.1 C of 164.4 mAh/g or higher, a capacity retention rate of 97.1% or higher after 100 cycles at 0.1 C, a discharge capacity at 1 C of 149.3 mAh/g or higher, and a capacity retention rate of 94.3% or higher after 100 cycles at 1 C, which is superior to the electrochemical performance of a cathode material prepared from the ferric phosphate in Comparative Example 1.

The above examples are preferred embodiments of the present disclosure. However, the embodiments of the present disclosure are not limited by the above examples. Any change, modification, substitution, combination, and simplification made without departing from the spiritual essence and principle of the present disclosure should be an equivalent replacement mode, and all are included in the protection scope of the present disclosure.

1. A preparation method for a porous ferric phosphate, comprising the following steps:
(1) mixing a phosphorus-iron solution with an aluminum-containing alkaline solution to allow a co-precipitation reaction;
(2) subjecting a reacted system obtained in step (1) to solid-liquid separation (SLS) to obtain a precipitate;
(3) subjecting the precipitate obtained in step (2) to a reaction with phosphine under heating;
(4) after the reaction is completed, cooling a precipitate treated in step (3), and soaking a cooled precipitate in a weak acid solution; and
(5) subjecting a system obtained in step (4) to SLS to obtain a solid, and subjecting the solid to aerobic calcination to obtain the porous iron phosphate;
wherein the phosphorus-iron solution is prepared from an iron source, a phosphorus source, and a strong acid; in the phosphorus-iron solution, a molar ratio of iron element to phosphorus element is 1.0 to 1.6 and a concentration of iron ions is 0.5 mol/L to 2.0 mol/L; and the phosphorus-iron solution has a pH less than 1;
in the aluminum-containing alkaline solution, a concentration of sodium hydroxide is 1.0 mol/L to 4.0 mol/L and a concentration of sodium tetrahydroxoaluminate is 0.05 mol/L to 0.4 mol/L; and
the mixing in step (1) is conducted as follows: concurrently feeding the phosphorus-iron solution and the aluminum-containing alkaline solution into a reactor to allow a reaction at 80° C. to 95° C., during which a reaction system is continuously stirred and a pH of the reaction system is controlled at 5 to 6.

2-4. (canceled)

5. The preparation method for the porous ferric phosphate according to claim 1, wherein in step (3), the precipitate is placed at a lower vent of a tube furnace, and anhydrous sodium hypophosphite is placed at an upper vent of the tube furnace and heated for decomposition to produce a phosphine gas, wherein a mass ratio of the anhydrous sodium hypophosphite to the precipitate is (4-8):1.

6. The preparation method for the porous ferric phosphate according to claim 5, wherein the heating in the tube furnace in step (3) is conducted as follows:
heating at a heating rate of 2° C./min to 5° C./min to 300° C. to 400° C., and holding the temperature for 120 min to 180 min.

7. The preparation method for the porous ferric phosphate according to claim 1, wherein the weak acid solution in step (4) is an acetic acid solution with a concentration of 0.1 mol/L to 0.5 mol/L.

8. The preparation method for the porous ferric phosphate according to claim 1, wherein in step (4), the precipitate is cooled to 10° C. or lower, and then soaked in the weak acid solution at 2° C. to 10° C. at a solid-to-liquid ratio of 1 to 5 g/mL.

9. The preparation method for the porous ferric phosphate according to claim 1, wherein the aerobic calcination in step (5) is conducted at 500° C. to 800° C. for 0.5 h to 1 h.

10. A porous ferric phosphate prepared by the preparation method according to claim 1.

11. A porous ferric phosphate prepared by the preparation method according to claim 5.

12. A porous ferric phosphate prepared by the preparation method according to claim 6.

13. A porous ferric phosphate prepared by the preparation method according to claim 7.

14. A porous ferric phosphate prepared by the preparation method according to claim 8.

15. A porous ferric phosphate prepared by the preparation method according to claim 9.
